(19) United States
(12) Patent Application Publication
(10) Pub. No.: US 2026/0227882 A1
(43) Pub. Date: Aug. 6, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KENTA SHINYA, Kanagawa (JP)

(21) Appl. No.: 19/458,317

(22) Filed: Jan. 23, 2026

(30) Foreign Application Priority Data
Jan. 31, 2025 (JP) 2025-014961

(51) Int. Cl. G06F 3/04815; G06F 3/01; G06F 3/04817

(52) U.S. Cl. CPC G06F 3/04815; G06F 3/013; G06F 3/04817; G06F 2203/04804

(57) ABSTRACT

Information processing apparatuses, information processing methods, and storage mediums are provided herein. One or more information processing apparatuses for performing a process for displaying a predetermined three-dimensional space as viewed from a user include: one or more processors that operate to: extract one or more virtual objects placed in a direction viewed by the user in the predetermined three-dimensional space; change displaying of the extracted virtual objects such that the extracted virtual objects can be identified; and determine, based on an operation by the user, any one of the extracted virtual objects as a processing target.

### BACKGROUND

### Field of the Technology

The present disclosure relates to one or more embodiments of a process of displaying an image, an information processing apparatus, and a storage medium.

### Description of the Related Art

There are cross-reality (XR) technologies such as virtual reality (VR), augmented reality (AR), and mixed reality (MR). In XR, a three-dimensional space may be presented to a user via a head-mounted display (HMD), and there is a method by which the user may manipulate virtual objects present in the three-dimensional space.

The specification of US Patent Application Publication No. 2024/0103613 discloses a method in which a user gazes at a virtual object and then performs a predetermined operation, thereby making the virtual object that the user gazed at an operation target.

### SUMMARY

One or more aspects of the present disclosure aim to enable a user to designate a virtual object that is occluded by another virtual object.

One or more embodiments of an information processing apparatus according to the present disclosure may be an information processing apparatus for performing a process for displaying a predetermined three-dimensional space as viewed from or by a user, and the information processing apparatus may include: one or more processors that operate to: extract one or more virtual objects placed in a direction viewed by the user in the predetermined three-dimensional space; change a display of the extracted one or more virtual objects such that the extracted one or more virtual objects operate to be identified; and determine, based on an operation by the user, any one of the extracted one or more virtual objects as a processing target.

According to other aspects of the present disclosure, one or more additional information processing apparatuses, one or more information processing methods, and one or more storage mediums are discussed herein. Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating at least one embodiment example of a hardware configuration in accordance with one or more aspects of the present disclosure;

FIG. 2 is a diagram illustrating at least one embodiment example of a functional configuration in accordance with one or more aspects of the present disclosure;

FIG. 3 is a flowchart for describing the flow of at least one embodiment of processing of displaying a virtual object in accordance with one or more aspects of the present disclosure;

FIG. 4 is a diagram for describing at least one embodiment for a display of virtual objects in accordance with one or more aspects of the present disclosure;

FIG. 5 is a diagram for describing at least one embodiment for a display of thumbnails in accordance with one or more aspects of the present disclosure;

FIG. 6 is a diagram for describing at least one embodiment for a display of virtual objects in accordance with one or more aspects of the present disclosure;

FIG. 7 is a diagram for describing at least one embodiment for a display of virtual objects in accordance with one or more aspects of the present disclosure;

FIG. 8 is a diagram illustrating at least one embodiment example of a functional configuration in accordance with one or more aspects of the present disclosure;

FIG. 9 is a flowchart for describing the flow of at least one embodiment of processing of displaying a virtual object in accordance with one or more aspects of the present disclosure;

FIG. 10 is a diagram for describing at least one embodiment for a display of virtual objects in accordance with one or more aspects of the present disclosure;

FIG. 11A and FIG. 11B are diagrams for describing one or more embodiments for a display of virtual objects in accordance with one or more aspects of the present disclosure;

FIG. 12 is a diagram for describing at least one embodiment for a display of virtual objects in accordance with one or more aspects of the present disclosure;

FIG. 13A and FIG. 13B are diagrams for describing one or more embodiments for a display of virtual objects in accordance with one or more aspects of the present disclosure;

FIG. 14 is a diagram illustrating at least one embodiment example of a functional configuration in accordance with one or more aspects of the present disclosure;

FIG. 15 is a flowchart for describing the flow of at least one embodiment of processing of displaying a virtual object in accordance with one or more aspects of the present disclosure;

FIG. 16 is a diagram for describing at least one embodiment of a map on which icons are displayed in accordance with one or more aspects of the present disclosure; and

FIG. 17A to FIG. 17C are diagrams for describing one or more embodiments of maps on which icons are displayed in accordance with one or more aspects of the present disclosure.

### DESCRIPTION OF THE EMBODIMENTS

Hereinafter, a description is given of embodiments according to the present disclosure with reference to the drawings. Note that the following embodiments are not intended to limit the technology of the present disclosure, and all of the combinations of the characteristics described in the following embodiments are not necessarily essential to the solutions provided as the technology of the present disclosure. The configurations of the following embodiments may be corrected or modified as appropriate depending on the specification of an apparatus to which the technology of the present disclosure is applied and various conditions (such as conditions and environment of use). Further, configurations made by appropriately combining parts of the following embodiments are also possible. In the description of the following embodiments, the same configurations or features are assigned the same reference numbers or codes.

### Configurations of One or More Embodiments

In one or more embodiments, for a group of windows that are displayed so as to be in the front direction of a user who is using a display device such as an HMD, thumbnails thereof are arranged side by side and displayed in front of the user. Further, one or more methods that enable the user to select a n occluded (shielded) window by selecting a thumbnail through a user operation are described. In one or more embodiments, windows are described as an example of virtual objects; however, the virtual objects may be other than the windows.

### Hardware Configuration for One or More Embodiments

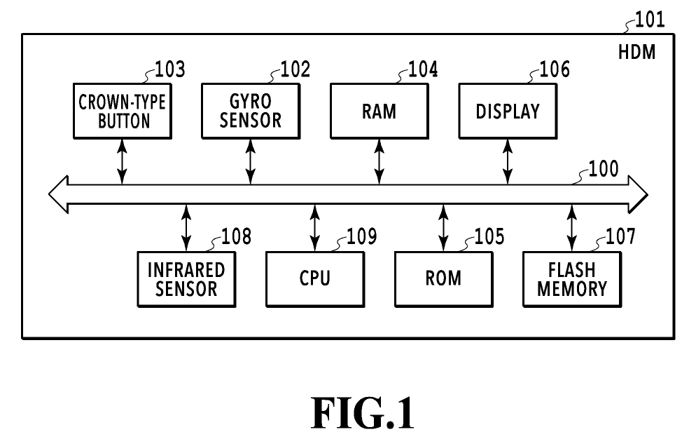

FIG. 1 is a diagram illustrating an example of the hardware configuration related to the HMD 101 according to one or more embodiments. The HMD 101 includes the CPU (Central Processing Unit) 109, the RAM (Random Access Memory) 104, the ROM (Read Only Memory) 105, and the flash memory 107. The HMD 101 further includes the display 106, the crown-type button 103, the infrared sensor 108, and the gyro sensor 102. The respective units are connected to each other so as to be capable of transmitting and receiving information via the data bus 100.

The ROM 105 is a storage unit that stores control programs and the like. The flash memory 107 is a storage unit that stores information processing programs and the like. The RAM 104 functions as a main memory, a work area, etc., of the CPU 109.

The CPU 109 executes various kinds of control processing by reading out control programs stored in the ROM 105, loading them into the RAM 104, and executing the loaded control programs. The CPU 109 executes various kinds of information processing by reading out information processing programs stored in the flash memory 107, loading them into the RAM 104, and executing the loaded information processing programs. The CPU 109 executes these programs to display a rendering image of a three-dimensional space such as a virtual space on the display 106.

The infrared sensor 108 outputs line-of-sight information of the user wearing the HMD 101. The gyro sensor 102 outputs an orientation of the HMD 101. That is, in a case where the HMD 101 is a device worn on the user's face, the gyro sensor 102 outputs information about the orientation of the user's face. The crown-type button 103 is a button that may be rotated or pushed.

### Functional Configuration for One or More Embodiments

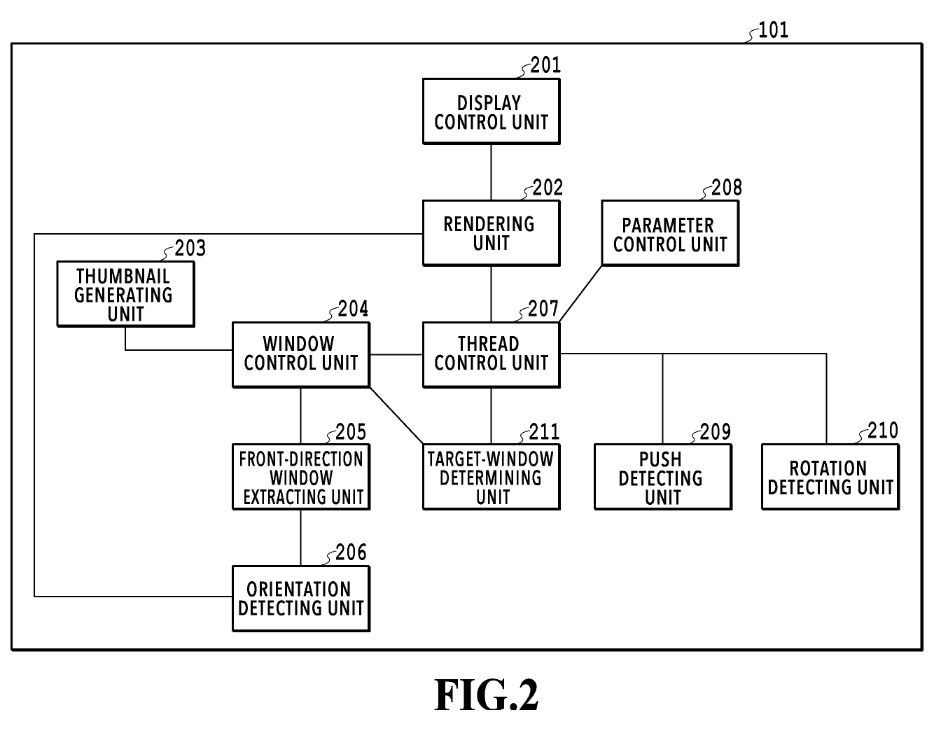

FIG. 2 is a diagram illustrating an example of the functional configuration included in the HMD 101 of one or more embodiments. The HMD 101 of one or more embodiments is assumed to be a device that has functions as an information processing apparatus that performs processing of displaying an image on the display 106 of the HMD 101. FIG. 2 illustrates an example of the functional configuration of the HMD 101 as an information processing apparatus.

The window control unit 204 controls a window, which is a framework arranged in a three-dimensional space such as a virtual space to display the execution contents of an application or a program. The rendering unit 202 generates a rendering image representing a three-dimensional space as viewed from the position of the user so that the image appears to be the three-dimensional space viewed by the user. The display control unit 201 performs processing of displaying a rendering image on the display 106. The orientation detecting unit 206 detects the orientation of the user wearing the HMD 101, based on an output result of the gyro sensor 102. The parameter control unit 208 controls parameters for determining the currently selected window among the windows in the three-dimensional space. The push detecting unit 209 detects a push of the crown-type button 103. The rotation detecting unit 210 detects the rotation of the crown-type button 103.

The functions of the thumbnail generating unit 203, the front-direction window extracting unit 205, the thread control unit 207, and the target-window determining unit 211 are described later with reference to the flowcharts.

Each functional unit included in the HMD 101 illustrated in FIG. 2 is implemented by the CPU 109 executing a predetermined program in one or more embodiments; however, there is no such limitation. Alternatively, for example, hardware such as a GPU (Graphics Processing Unit) for speeding up computation, an FPGA (Field Programmable Gate Array), or the like may be utilized. Each functional unit may be implemented through cooperation of software and hardware such as a dedicated IC, or part or all of the functions may be implemented by hardware alone.

### Flowchart that may be used in One or More Embodiments

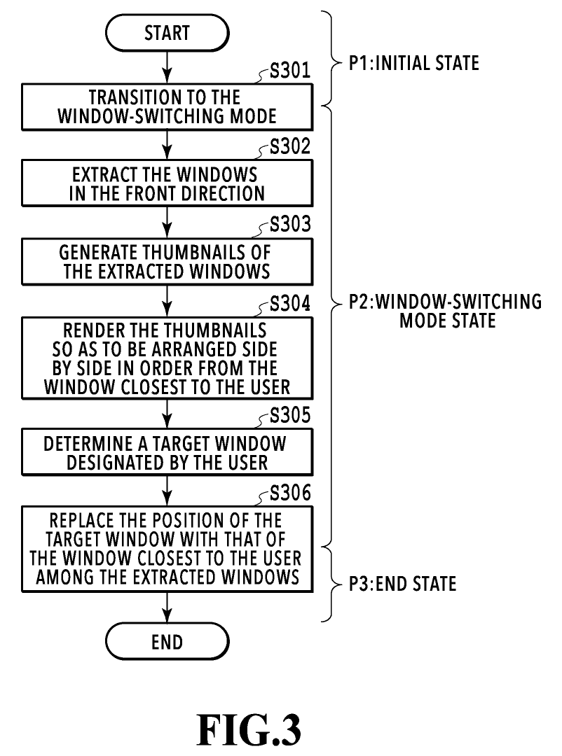

FIG. 3 is a flowchart for describing the flow of processing of displaying a window, which is a virtual object, according to one or more embodiments. The series of processes illustrated in FIG. 3 is implemented by a program stored in the ROM 105 or the flash memory 107 being loaded into the RAM 104 and executed by the CPU 109. Alternatively, part or all of the functions in the steps of FIG. 3 may be implemented by hardware such as an ASIC or an electronic circuit. The symbol "S" in the description of each process indicates that it is a step in the flowchart, and the same applies to the following flowcharts.

In S301, upon detecting a predetermined operation by the user for switching from the initial state P1 to the window-switching mode state P2, the thread control unit 207 performs a mode transition from the initial state P1 to the window-switching mode state P2. In one or more embodiments, the predetermined operation is, for example, a long press of the crown-type button 103 by the user. If the user performs a long press on the crown-type button 103, the push detecting unit 209 detects the long press of the crown-type button 103 and outputs the detection information to the thread control unit 207. As a result, the thread control unit 207 may detect that an operation for switching to the window-switching mode state P2 has been performed.

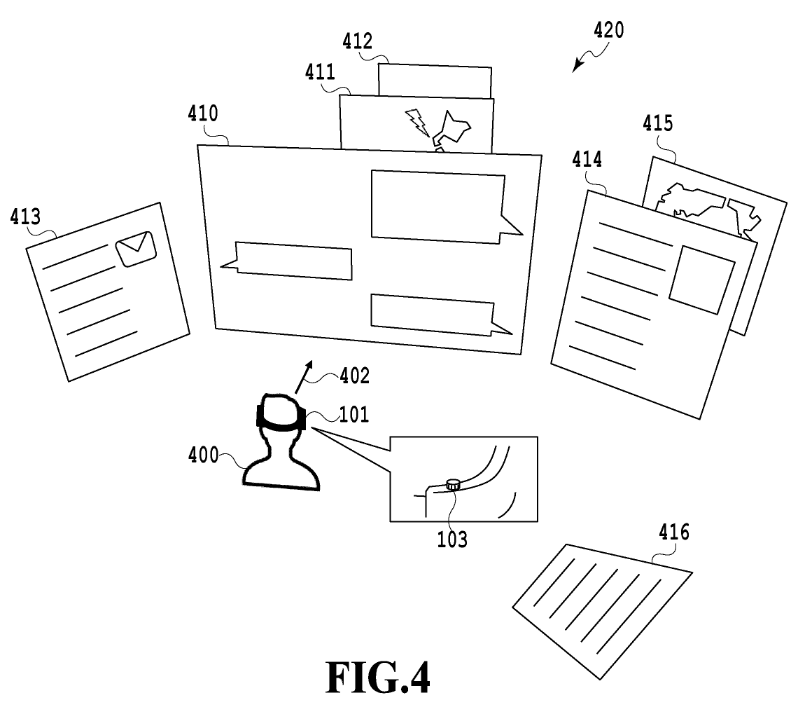

FIG. 4 is a diagram illustrating an example of the initial state P1 of a three-dimensional space generated such that a user wearing the HMD 101 is present therein. The user 400 is a user who wears the HMD 101. It is assumed that the user 400 is viewing, via the display 106, a rendering image generated by rendering the three-dimensional space 420, which is controlled so that the user 400 is present therein, as seen by the user 400. The orientation of the user 400 in the three-dimensional space 420 is interlocked with the orientation of the actual user 400. The three-dimensional space 420 may be a virtually-created space, a space rendered like the real world, or the actual real-world space in which the user 400 exists.

As illustrated in FIG. 4, in one or more embodiments, it is assumed that control is performed such that the multiple windows 410 to 416 are arranged as virtually-created objects (virtual objects) in the three-dimensional space 420. The respective windows 410 to 416 are described as windows for displaying the contents of various applications, such as a message app, a weather app, and a map app, for example. The multiple windows 410 to 416 are controlled by the window control unit 204. The multiple windows 410 to 416 may be arranged in a manner overlapping with each other. For this reason, some windows, such as the windows 411, 412, and 415, may be displayed in a manner occluded by another window 410 or 414 as viewed from the user 400, and thus the user 400 may not be able to identify the contents of the windows 411, 412, and 415.

The flowchart in FIG. 3 starts with a state in which a rendering image obtained by rendering the three-dimensional space 420 as viewed by a user, such as that illustrated in FIG. 4, is displayed on the display 106. In one or more embodiments, the window 416 behind the user 400 is not included in the range corresponding to the field of view of the user 400, and thus is not included in the rendering image.

The state at the start of the flowchart in FIG. 3 is referred to as the initial state P1. A method for enabling the user 400 to designate the window 411 that is occluded by the window 410 is described with reference to the flowchart of FIG. 3. After transitioning to the window-switching mode state P2, the processing of S302 to S306 will be sequentially executed.

In S302, the front-direction window extracting unit 205 extracts the windows that are arranged so as to be present in the front direction 402 of the user 400 from among the multiple windows 410 to 416 in the three-dimensional space 420. In one or more embodiments, the front direction is the direction in which the face of the user 400 is oriented. The windows extracted by the front-direction window extracting unit 205 are referred to as designation candidate windows.

The method in which the front-direction window extracting unit 205 extracts the windows present in the front direction 402 is performed as described below, for example. First, based on the orientation detected by the orientation detecting unit 206, the front direction 402 of the user 400 in the three-dimensional space 420 is detected. The front-direction window extracting unit 205 selects a processing-target window from among the multiple windows 410 to 416 in the three-dimensional space 420. Then, in a case where the angle formed by the vector from the user 400 to the center of the processing-target window and the vector indicating the front direction 402 falls within a predetermined range, the processing-target window is extracted as a window that is present in the front direction 402 of the user 400. Alternatively, it is also possible to extract the processing-target window as a window that is present in the front direction 402 of the user 400 in a case where the area of the processing-target window has an intersection point with the vector indicating the front direction 402. For example, in a case where the three-dimensional space 420 is controlled to be as illustrated in FIG. 4, of the multiple windows 410 to 416, the three windows 410, 411, and 412 located in the front direction 402 of the user 400 are extracted as the designation candidate windows.

Note that the HMD 101 includes the infrared sensor 108 that outputs line-of-sight information of the user wearing the HMD 101. Therefore, in S302, it is also possible for the front-direction window extracting unit 205 to extract, from among the multiple windows 410 to 416 in the three-dimensional space 420, the windows that are arranged so as to be present in the line-of-sight direction of the user 400. That is, in S302, it is preferred (or, in one or more embodiments, may be required) that the windows in the direction viewed by the user 400 based on the orientation of the face or the pupils of the user 400 or the like be extracted.

In S303, the thumbnail generating unit 203 generates thumbnail images corresponding to the respective designation candidate windows 410 to 412 extracted in S302.

In S304, the window control unit 204 generates a new window and displays the thumbnails generated in S303 side by side inside the new window. Further, the window control unit 204 performs processing such that the new window is arranged in front of the user 400 in the three-dimensional space 420. Specifically, the thread control unit 207 outputs information about the new window to the rendering unit 202. The rendering unit 202 generates a rendering image in which the new window is located in front of the user in the three-dimensional space 420, based on a detection result of the user's orientation obtained by the orientation detecting unit 206. The display control unit 201 displays the generated rendering image on the display 106 of the HMD 101.

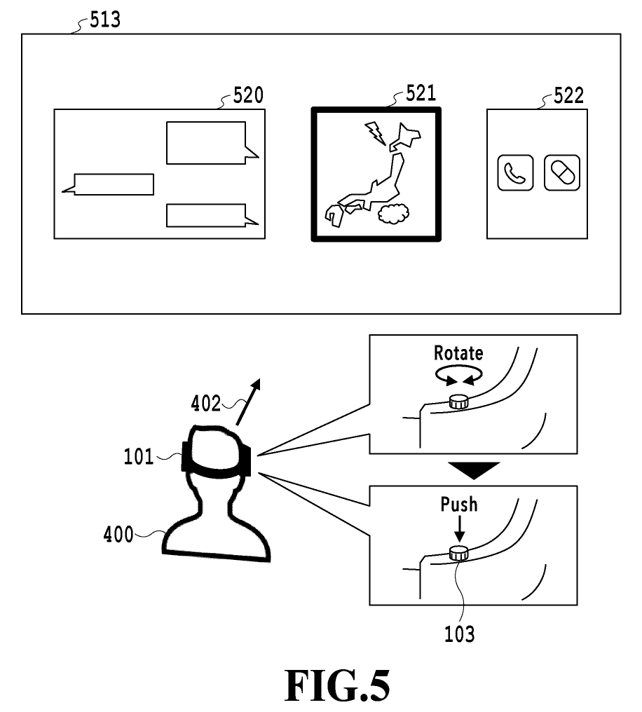

The window control unit 204 determines the order in which the thumbnails 520 to 522 corresponding to the designation candidate windows 410 to 412 are arranged, based on the distances between the user 400 and the candidate windows 410 to 412. For example, the window control unit 204 assigns indexes indicating the display order to the designation candidate windows 410 to 412 according to the distances between the positions of the respective designation candidate windows 410 to 412 and the position of the user 400. The window control unit 204 assigns the indexes in order from the thumbnail 520 corresponding to the designation candidate window 410 closest to the user. For example, the window control unit 204 assigns an index of "1" to the window 410, "2" to the window 411, and "3" to the window 412. Further, the window control unit 204 arranges the thumbnails in the new window such that the thumbnails are arranged in the order of the indexes from the left, starting with the thumbnail representing the window with the index "1." By displaying the thumbnails in this way, it is possible to reduce misidentification by the user 400 at the time of selecting a window in the subsequent stage. FIG. 5 is a diagram illustrating an example of the new window generated in S304 and displayed on the display 106 of the HMD 101. The new window 513 includes the thumbnails 520 to 522 corresponding to the respective designation candidate windows 410 to 412.

Any one of the thumbnails 520 to 522 is in a selected state. The parameter control unit 208 defines and holds one parameter that represents the index of the selected thumbnail (window). The parameter controlled by the parameter control unit 208 may take any value as long as a relationship is maintained such that the index being selected is determined once the value of the parameter is determined. For example, the parameter in one or more embodiments is a variable that stores any one of the values "1", "2", and "3" indicating an index.

As illustrated in FIG. 5, among the thumbnails 520 to 522 included in the new window 513, the manner in which the thumbnail indicating the currently selected window is displayed may be changed. That is, the manner in which the thumbnail indicated by the value of the parameter controlled by the parameter control unit 208 is displayed may be changed. For example, in FIG. 5, the value of the parameter is "2", and thus the thumbnail 521 corresponding to the window 411 with the index "2" is selected. As illustrated in FIG. 5, the appearance of the selected thumbnail 521 may be changed to make it easier for the user 400 to recognize which thumbnail is currently selected. For example, the selected thumbnail 521 may be rendered with a luminous periphery.

In S305, the thread control unit 207 determines one window designated by the user from among the designation candidate windows 410 to 412.

If the user 400 rotates the crown-type button 103, the rotation detecting unit 210 detects the direction and amount of rotation. Then, the parameter control unit 208 updates the value of the parameter according to the direction and amount of rotation of the crown-type button 103. As a result, the selected thumbnail with a luminous periphery in FIG. 5 is changed. Further, if the user 400 pushes the crown-type button 103, the push detecting unit 209 detects the push. Then, from among the thumbnails 520 to 522 included in the new window 513, the target-window determining unit 211 identifies the thumbnail selected at the time the crown-type button 103 was pushed. The target-window determining unit 211 determines the window corresponding to the identified thumbnail as the processing-target window (target window), which is the window designated by the user. For example, if the user 400 pushes the crown-type button 103 with the thumbnail 521 being selected as illustrated in FIG. 5, the window 411 corresponding to the thumbnail 521 is determined as the processing-target window.

In S306, the window control unit 204 changes the position of the processing-target window determined in S305 to a position not occluded by other windows in the front direction 402 of the user 400.

For example, assume that the windows are arranged as illustrated in FIG. 4 in the initial state P1. Further, assume that, in S305, the window 411 is determined as the processing-target window designated by the user 400. In this case, in S306, the window control unit 204 changes the position of the processing-target window 411 to the position of the window 410, which is the closest to the user 400 among the other designation candidate windows 410 to 412. Further, the thread control unit 207 outputs information about the windows 410 to 412 whose positions have been changed to the rendering unit 202. The rendering unit 202 generates a rendering image in which the designation candidate windows 410 to 412 are arranged in the changed positions, based on a detection result of the user's orientation obtained by the orientation detecting unit 206. The display control unit 201 displays the generated rendering image on the display 106 of the HMD 101. Upon completion of the display, the state transitions to the end state P3.

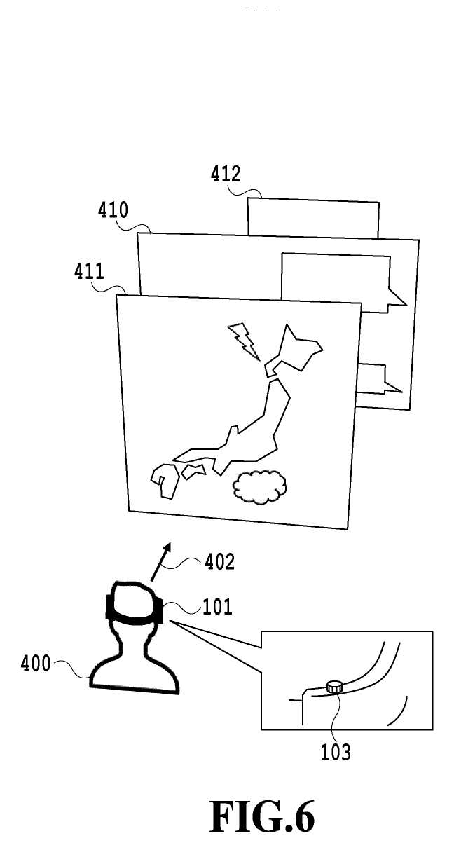

FIG. 6 is a diagram illustrating at least one embodiment of the three-dimensional space 420 in the end state P3 after the position of the processing-target window 411 is changed in S306. In FIG. 6, the windows other than the designation candidate windows 410 to 412 are omitted from the illustration. In this way, as a result of the processing in S306, the windows are controlled so that the window 411, which is the processing-target window designated by the user 400, is in front of the user 400.

Note that there is no limitation on the method of displaying the processing-target window in S306 as long as the method allows the user to identify the contents of the processing-target window.

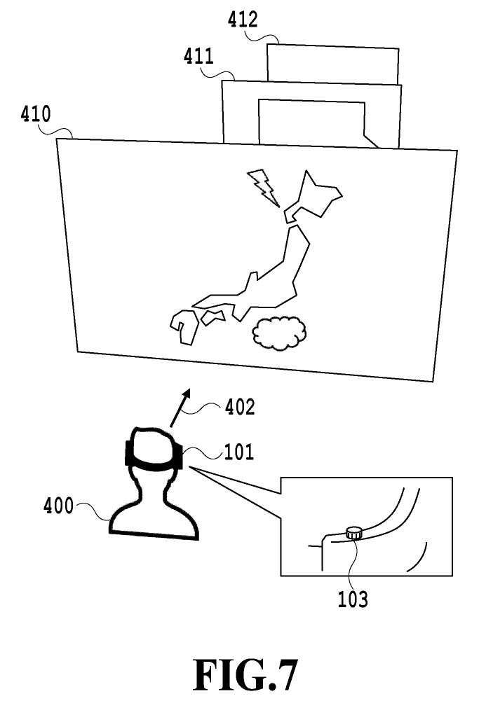

FIG. 7 is a diagram illustrating at least one embodiment of the three-dimensional space 420 in the end state P3 for describing another example of the processing of displaying a processing-target window in S306. In FIG. 7, the windows other than the designation candidate windows 410 to 412 are omitted from the illustration. For example, in S306, the window control unit 204 may cause the contents displayed in the processing-target window 411 in the initial state P1 illustrated in FIG. 4 to be displayed in the window 410 which is the closest to the user 400. The window control unit 204 may cause the contents displayed in the window 410 which is the closest to the user 400 to be displayed in the processing-target window 411 determined in S305. In this way, the contents rendered in the windows may be replaced, without changing the positions of the window 410 in front of the user and the window 411 designated by the user from the initial state P1.

Alternatively, in S306, the window control unit 204 may change the position of the processing-target window 411 determined in S305 to a predetermined position. Alternatively, in S306, the window control unit 204 does not necessarily need to automatically change the position of the processing-target window 411 determined in S305, but may make the processing-target window 411 movable according to an operation by the user 400.

As described above, according to one or more embodiments, even in a case where a window is occluded by another window in the initial state P1, the occluded window may be moved by going through the window-switching mode state P2.

As described above, according to one or more embodiments, even in a case where a virtual object is occluded by another virtual object, the user may gaze at the occluded virtual object. Therefore, the occluded virtual object may be an operation target.

According to the present disclosure, it is possible for the user to designate a virtual object that is occluded by another virtual object.

### Configurations for One or More Additional Embodiments

In one or more additional embodiments, a description is given of a method in which windows in the line-of-sight direction of the user are extracted and the opacity of the extracted windows is changed, thereby enabling the user to easily see and select an occluded window. Regarding one or more additional embodiments, the differences from the aforementioned one or more embodiments are mainly described. Not-specified parts have the same configurations and processes as those in the aforementioned one or more embodiments.

### Functional Configuration of One or More Additional Embodiments

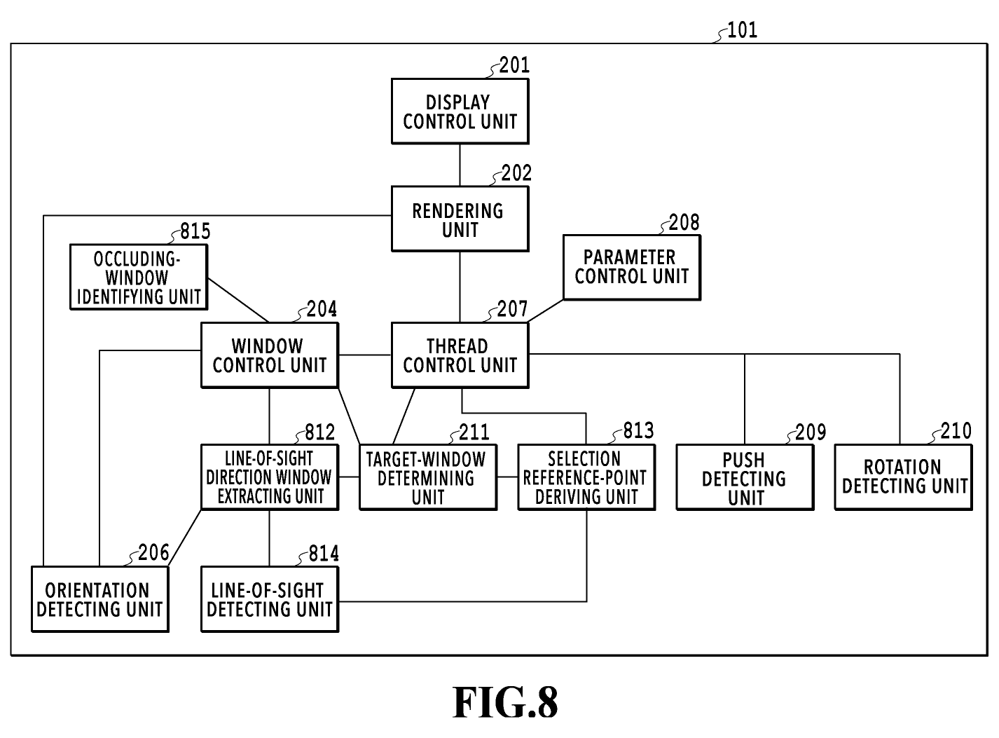

FIG. 8 is a diagram illustrating an example of the functional configuration included in the HMD 101 of one or more additional embodiments. In FIG. 8, the same functional units as those in FIG. 2 are assigned the same numbers as those in FIG. 2 so that the descriptions thereof are omitted. The HMD 101 of one or more additional embodiments includes the line-of-sight direction window extracting unit 812, the selection reference-point deriving unit 813, the line-of-sight detecting unit 814, and the occluding-window identifying unit 815 as functional units not included in FIG. 2. The line-of-sight detecting unit 814 detects the line of sight of the user 400 wearing the HMD 101, based on an output result of the infrared sensor 108. The functions of the line-of-sight direction window extracting unit 812, the selection reference-point deriving unit 813, and the occluding-window identifying unit 815 are described together with the flowchart below.

### Flowchart that may be used in One or More Additional Embodiments

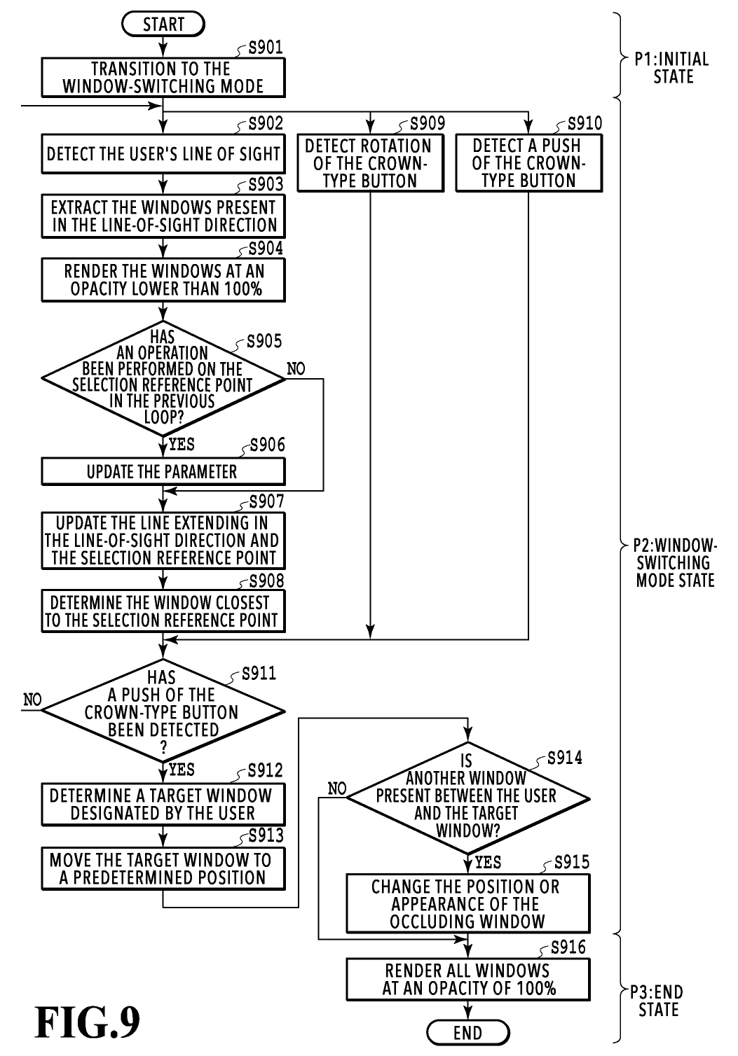

FIG. 9 is a flowchart for describing the flow of the processing of displaying a window according to one or more additional embodiments.

S901 is the same step as S301. In S901, upon detecting a predetermined operation by the user for switching from the initial state P1 to the window-switching mode state P2, the thread control unit 207 performs a mode transition from the initial state P1 to the window-switching mode state P2.

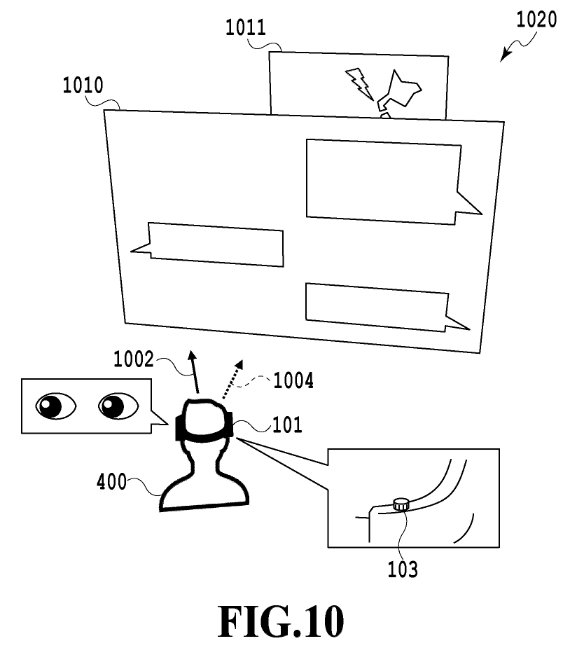

FIG. 10 is a diagram illustrating an example of the initial state P1 of a three-dimensional space that is presented such that a user wearing the HMD 101 is present therein. It is assumed that the user 400 is viewing the three-dimensional space 1020 displayed on the display 106. As illustrated in FIG. 10, in one or more additional embodiments, it is assumed that display control is performed such that the multiple windows 1010 and 1011 are displayed in the three-dimensional space 1020.

After transitioning from the initial state P1 to the window-switching mode state P2, the loop processing of S902 to S910 is executed. In the loop processing, the processing group of S902 to S908, the processing of S909, and the processing of S910 are executed independently and in parallel.

In S909, in a case where the crown-type button 103 is rotated by the user 400, the rotation detecting unit 210 detects the rotation and notifies the thread control unit 207 that rotation has been detected.

In S910, in a case where the crown-type button 103 is pushed by the user 400, the push detecting unit 209 detects the push and notifies the thread control unit 207 that a push has been detected.

Next, a description is given of the processing group of S902 to S908. In S902, the line-of-sight detecting unit 814 detects the line-of-sight direction 1004 of the user 400.

In S903, the line-of-sight direction window extracting unit 812 extracts the windows that are present in the line-of-sight direction 1004 of the user 400 from among the windows controlled by the window control unit 204, based on a line-of-sight detection result obtained by the line-of-sight detecting unit 814. The windows extracted by the line-of-sight direction window extracting unit 812 are designation candidate windows in one or more additional embodiments. In such a case where the line-of-sight detection result is provided as coordinates relative to the user 400, the line-of-sight direction window extracting unit 812 may extract the designation candidate windows by also using, as necessary, an orientation detection result obtained by the orientation detecting unit 206.

For example, the line-of-sight direction window extracting unit 812 extracts the windows that are present in the line-of-sight direction 1004 as described below. The line-of-sight direction window extracting unit 812 selects a processing-target window from among the multiple windows in the three-dimensional space 1020. Further, in a case where the angle formed by the vector from the user 400 to the center of the processing-target window and the vector indicating the line-of-sight direction 1004 falls within a predetermined value or lower, the processing-target window is extracted as a window that is present in the line-of-sight direction 1004 of the user 400. Alternatively, it is also possible to extract the processing-target window as a window that is present in the line-of-sight direction 1004 of the user 400 in a case where the area of the processing-target window has an intersection point with the vector indicating the line-of-sight direction 1004. For example, in a case where the three-dimensional space 1020 as illustrated in FIG. 10 is displayed, the two windows 1010 and 1011 present in the line-of-sight direction 1004 of the user 400 will be extracted as the designation candidate windows.

Note that, in S903, windows in front of the user may be extracted as designation candidate windows. That is, in S903, it is only necessary that the windows in the direction viewed by the user 400 are extracted.

In S904, the rendering unit 202 receives information about the designation candidate windows from the window control unit 204 via the thread control unit 207. The rendering unit 202 generates a rendering image by rendering each of the designation candidate windows at a predetermined opacity lower than 100% so that the user 400 may identify all the designation candidate windows. Further, the display control unit 201 displays the generated rendering image. For example, the rendering unit 202 renders the designation candidate windows present in the line-of-sight direction 1004 with a uniform opacity higher than 0% and lower than 100%. Alternatively, of the designation candidate windows, only those windows that have another window behind them may be rendered with an opacity lower than 100%.

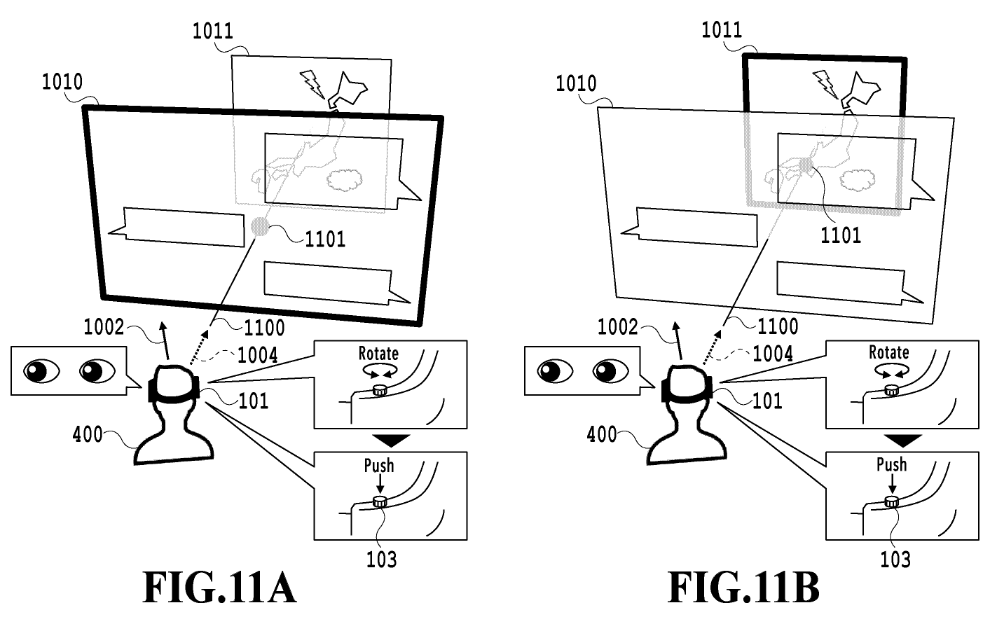

FIG. 11 is a diagram illustrating an example of window display according to one or more additional embodiments. In one or more additional embodiments, the designation candidate windows 1011 and 1010 present in the line-of-sight direction 1004 are displayed with an opacity lower than 100%. Therefore, even if a window, such as the window 1011, is occluded by the window 1010, the user 400 may identify the contents displayed in the window.

In S905, the parameter control unit 208 determines whether rotation of the crown-type button 103 is detected by the rotation detecting unit 210 in S909, which is in the previous loop processing. If it is determined that rotation of the crown-type button 103 is detected (YES in S905), the processing proceeds to S906; if not (NO in S905), the processing skips S906 and proceeds to S907.

In S906, the parameter control unit 208 updates the value of the parameter according to the rotation of the crown-type button 103. In one or more additional embodiments, the value of the parameter controlled by the parameter control unit 208 is a value that represents the distance from the user 400.

In S907, the selection reference-point deriving unit 813 acquires the current line-of-sight direction 1004 of the user 400 based on a line-of-sight detection result, and updates the position of the line 1100 that starts from the user 400 and extends in the line-of-sight direction 1004.

Further, in S907, the selection reference-point deriving unit 813 updates the position of the selection reference point 1101, which is a point on the updated line 1100. The selection reference point 1101 is a point on the line 1100 that is displayed at a position away from the user 400 by the distance indicated by a value of the parameter controlled by the parameter control unit 208. That is, in one or more additional embodiments, the selection reference point 1101 is displayed in the user's line of sight, and how far away from the user 400 the selection reference point 1101 is displayed is determined according to the amount of rotation of the crown-type button 103. In S907, a position distant from the user 400 along the line-of-sight direction 1004 by the value of the parameter may be calculated, and the calculated position may be set as the position of the selection reference point 1101. Note that, immediately after switching to the window-switching mode state P2, the user has not yet rotated the crown-type button 103 even once. In this case, in S907, the selection reference-point deriving unit 813 may not determine the position of the selection reference point 1101, or may determine the position of the selection reference point 1101 to be a default position.

In S908, from among the designation candidate windows extracted in S903, the target-window determining unit 211 determines the window closest to the position of the selection reference point 1101 updated in S907. The window determined in S908 becomes the currently selected window. As a method for calculating the distance between a window and the selection reference point 1101, for example, the Euclidean distance between the foot of a perpendicular line dropped from the selection reference point 1101 to each window and the selection reference point 1101 may be adopted.

Further, in the next step S904, the manner in which the selected window is displayed may be changed so as to be identifiable for the user. For example, in FIG. 11A, the selected window closest to the selection reference point 1101 is the window 1010. Therefore, in order to indicate that window 1010 is the selected window, the window 1010 is rendered with a luminous periphery in the illustration. Further, in FIG. 11B, since the window closest to the selection reference point 1101 is the window 1011, the window 1011 may be rendered with a luminous periphery. As illustrated in FIG. 11A and FIG. 11B, the line 1100 is also included as an image in the rendering image, but the line 1100 does not have to be included in the rendering image.

Further, to enable the user to more clearly identify the contents of the selected window, the rendering unit 202 may render the window closest to the selection reference point 1101 with an opacity lower than 100% but higher than the other windows. For example, the opacity of the window closest to the selection reference point 1101 may be set to about 60 to 80%. Since that window is not completely opaque even in this case, although there are other windows behind it, the user may still see the contents of the windows behind it.

In S911, the target-window determining unit 211 determines whether a push of the crown-type button 103 has been detected by the push detecting unit 209 in the previous step S910. If it is determined that a push of the crown-type button 103 has been detected (YES in S911), the loop processing of S902 to S910 ends, and the processing proceeds to S912. On the other hand, if a push of the crown-type button 103 has not been detected (NO in S911), the thread control unit 207 returns the processing to restart the loop processing of S902 to S910. That is, thereafter, the processing of S902 to S910 is repeatedly executed until the termination condition is met.

In S912, the target-window determining unit 211 determines the selected window, which is the window closest to the selection reference point 1101 at the time the crown-type button 103 is pushed, as the processing-target window designated by the user. For example, in a case where the crown-type button 103 is pushed in the state illustrated in FIG. 11B, the window 1011 is determined as the processing-target window.

In S913, the window control unit 204 moves the processing-target window, which is the window designated by the user, to a position far away from the user 400 by a predetermined distance in the front direction 1002.

In S914, the occluding-window identifying unit 815 determines whether a window (referred to as a occluding window) is present between the user 400 and the processing-target window designated by the user. For example, the occluding-window identifying unit 815 identifies, as occluding windows, windows other than the processing-target window that are included inside a quadrangular pyramid with the user 400 at the apex and the processing-target window at the base.

If the occluding-window identifying unit 815 determines that a occluding window is present (YES in S914), the processing proceeds to S915; if not (NO in S914), the processing skips S915 and proceeds to S916.

In S915, the window control unit 204 changes at least one of the position and the appearance of the occluding window. For example, the window control unit 204 moves the occluding window away from the user 400. Alternatively, the window control unit 204 may hide the occluding window.

In S916, the rendering unit 202 renders all the designation candidate windows 1010 and 1011 with an opacity of 100% to generate a rendering image. The display control unit 201 displays the generated rendering image on the display 106 of the HMD 101.

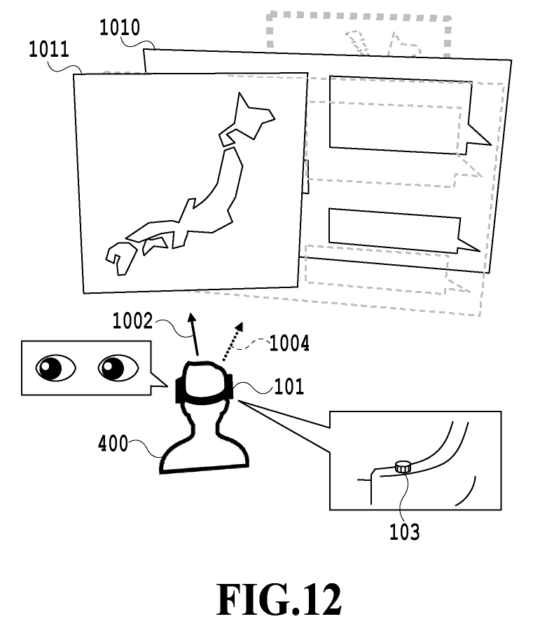

FIG. 12 is a diagram illustrating an example of a rendering image generated such that the user sees the three-dimensional space after the position of the processing-target window has been changed. As illustrated in FIG. 12, in the end state P3, the processing-target window 1011 designated by the user is displayed in front of the user 400 without being occluded by the other window 1010.

As described above, according to one or more additional embodiments, even in a case where the window 1011 is occluded by the window 1010 in the initial state P1, the window 1011 may be moved by going through the window-switching mode state P2.

Note that, in the above description, the distance to the user, which is a value of the parameter controlled by the parameter control unit 208 in one or more additional embodiments, is represented as the position of the selection reference point 1101. The method of representing a value of the parameter controlled by the parameter control unit 208 is not limited to the selection reference point 1101.

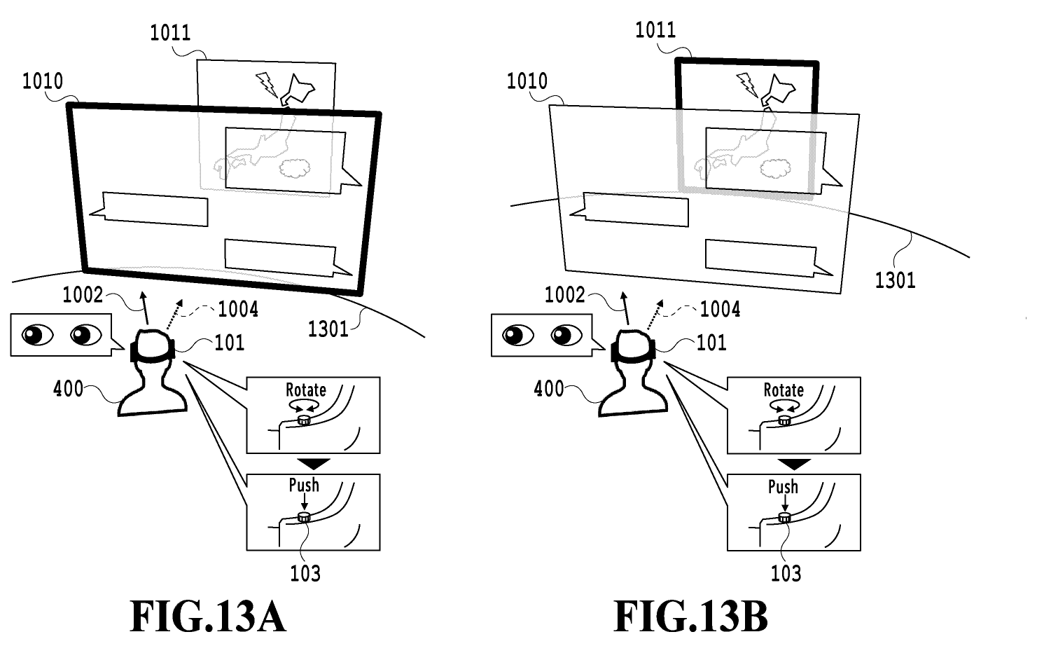

FIG. 13A and FIG. 13B are diagrams illustrating examples of at least one method in which a value of the parameter controlled by the parameter control unit 208 is represented as a circle. As illustrated in FIG. 13A and FIG. 13B, it is also possible to display the selection reference circle 1301 that is centered on the position of the user 400, has a plane that matches the line of sight of the user 400, and has a radius corresponding to the value of the parameter. In this case, in S908, the target-window determining unit 211 determines, as the selected window, the window closest to the intersection of the line-of-sight direction 1004 and the selection reference circle 1301 from among the designation candidate windows. Note that, regardless of whether the value of the parameter is represented as the selection reference point 1101 or the selection reference circle 1301, the window determined in S908 will be the same.

### Configurations of One or More Further Embodiments

In one or more further embodiments, a description is given of a method in which icons of extracted designation candidate windows are rendered on a map so that a user's selection is accepted based on line-of-sight detection. Regarding one or more further embodiments, the differences from the aforementioned one or more embodiments are mainly described. Not-specified parts have the same configurations and processes as those in the aforementioned one or more embodiments.

### Functional Configuration of One or More Further Embodiments

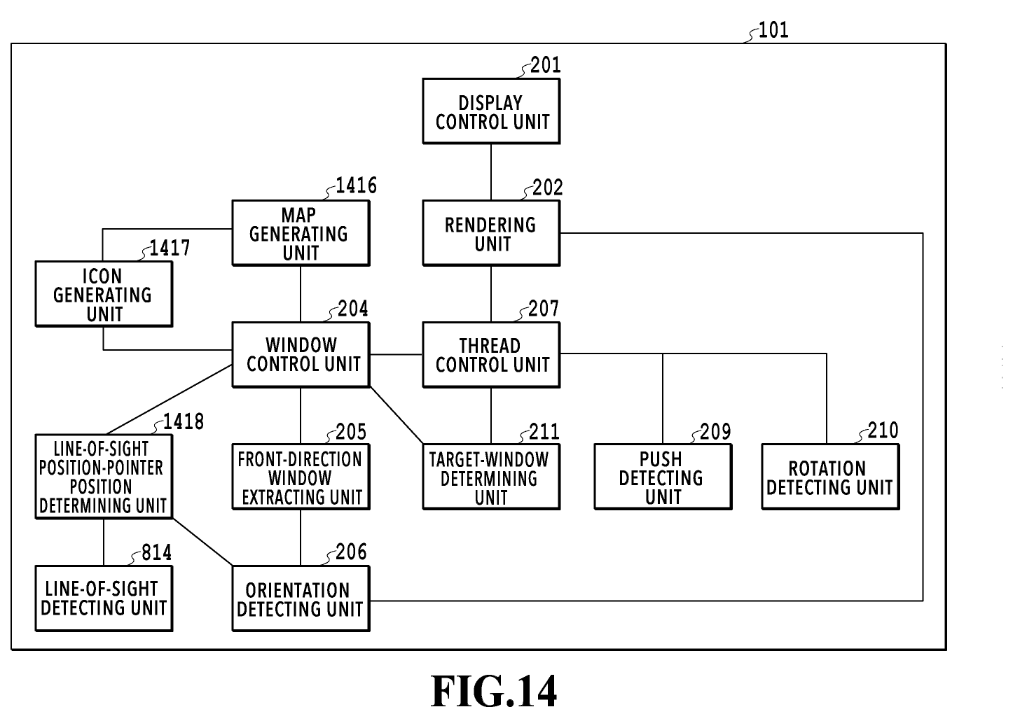

FIG. 14 is a diagram illustrating an example of the functional configuration included in the HMD 101 of one or more further embodiments. In FIG. 14, the same functional units as those in FIG. 2 or FIG. 8 are assigned the same numbers as those in FIG. 2 or FIG. 8 so that the descriptions thereof are omitted. The HMD 101 of one or more further embodiments further includes the map generating unit 1416, the icon generating unit 1417, and the line-of-sight position-pointer position determining unit 1418 as functional units not included in FIG. 2 or FIG. 8. A description is given about these functions together with the flowchart below.

### Flowchart that may be used in One or More Further Embodiments

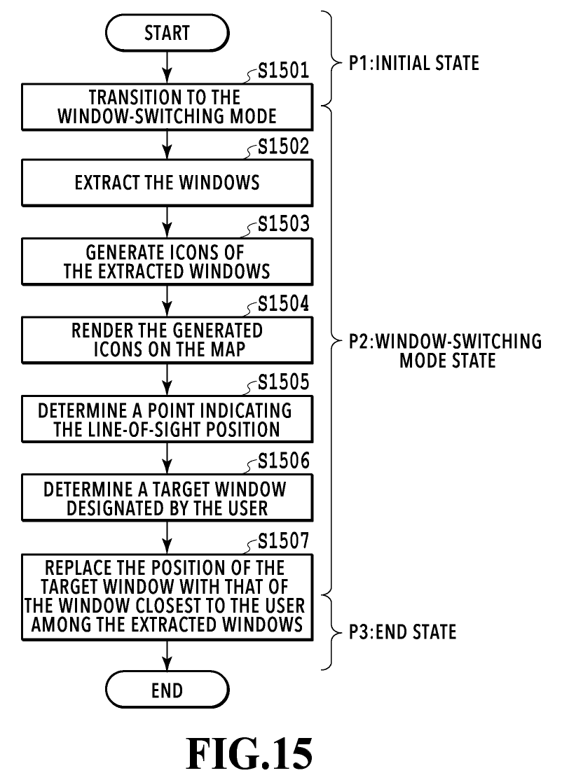

FIG. 15 is a flowchart for describing the flow of the processing of displaying a window according to one or more further embodiments. As in the aforementioned one or more embodiments, it is assumed that the state transitions from the initial state P1 to the window-switching mode state P2, and then transitions to the end state P3 after the user selects a window.

S1501 is the same step as S301 in FIG. 3. In S1501, upon detecting a predetermined operation by the user for switching from the initial state P1 to the window-switching mode state P2, the thread control unit 207 performs a mode transition from the initial state P1 to the window-switching mode state P2. It is assumed that the initial state P1 is that of FIG. 4, and the window control unit 204 controls the windows such that the windows 410 to 416 exist in the three-dimensional space 420.

In S1502, the front-direction window extracting unit 205 extracts the windows that are displayed so as to be present in the front direction 402 of the user 400. Further, the front-direction window extracting unit 205 may also extract other windows that exist in the three-dimensional space 420.

In S1503, the icon generating unit 1417 generates icons representing the respective windows in the three-dimensional space 420.

In S1504, the map generating unit 1416 generates a two-dimensional map of the three-dimensional space 420 as viewed from above, and the window control unit 204 arranges the icons generated in S1503 on the generated two-dimensional map.

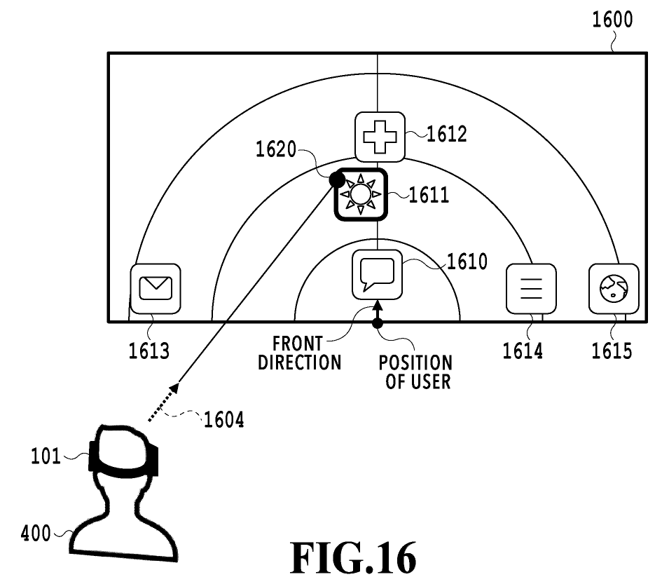

FIG. 16 is a diagram illustrating an embodiment example of the two-dimensional map generated in S1504. The two-dimensional map 1600 is, for example, a two-dimensional map that extends in a semicircular shape centered on the user 400, and is a bird's-eye view in which the upward direction on the map corresponds to the front direction of the user. A corresponding icon is arranged at a position on the two-dimensional map 1600 that corresponds to the position of a window in the three-dimensional space 420. FIG. 16 illustrates an example in which the icons 1610 to 1615 that correspond to the windows 410 to 415, whose positions are included in the two-dimensional map 1600 among the windows 410 to 416 present in the three-dimensional space 420, are arranged. The two-dimensional map 1600 is rendered by the rendering unit 202 together with an orientation detection result obtained by the orientation detecting unit 206, and is displayed on the display 106 by the display control unit 201.

In S1505, the line-of-sight position-pointer position determining unit 1418 determines the intersection of the line-of-sight direction 1604 and the two-dimensional map 1600 as the line-of-sight position-pointer, based on a line-of-sight detection result obtained by the line-of-sight detecting unit 814. As illustrated in FIG. 16, a point indicating the line-of-sight position-pointer 1620 is displayed on the two-dimensional map 1600.

In S1506, the target-window determining unit 211 identifies the selected window, based on the positional relationships between the line-of-sight position-pointer 1620 and the icons 1610 to 1615. For example, among the icons present at positions within a predetermined distance from the line-of-sight position-pointer 1620, the window corresponding to the icon that is closer to the line-of-sight position-pointer 1620 than any other icons is identified as being selected. Further, in parallel with the flowchart in FIG. 15, the thread control unit 207 stands by for the push detecting unit 209 to detect a push of the crown-type button 103 by the user. The target-window determining unit 211 determines the window selected at the time the push of the crown-type button 103 by the user was detected as the processing-target window designated by the user.

S1507 is a step similar to S306, in which the window control unit 204 changes the position of the processing-target window determined in S1506 to a position that may be identified by the user, such as in front of the user 400.

For example, assume that the user pushes the crown-type button 103 while looking at the icon 1611. In this case, as illustrated in FIG. 16, the crown-type button 103 is pushed in a state where the line-of-sight position-pointer 1620 is displayed near the icon 1611. Therefore, in FIG. 16, the window 411 corresponding to the icon 1611 is selected, and the selected window 411 is determined as the processing-target window designated by the user. As a result, in the end state P3, the processing-target window 411 is displayed in front of the user, as illustrated in FIG. 6.

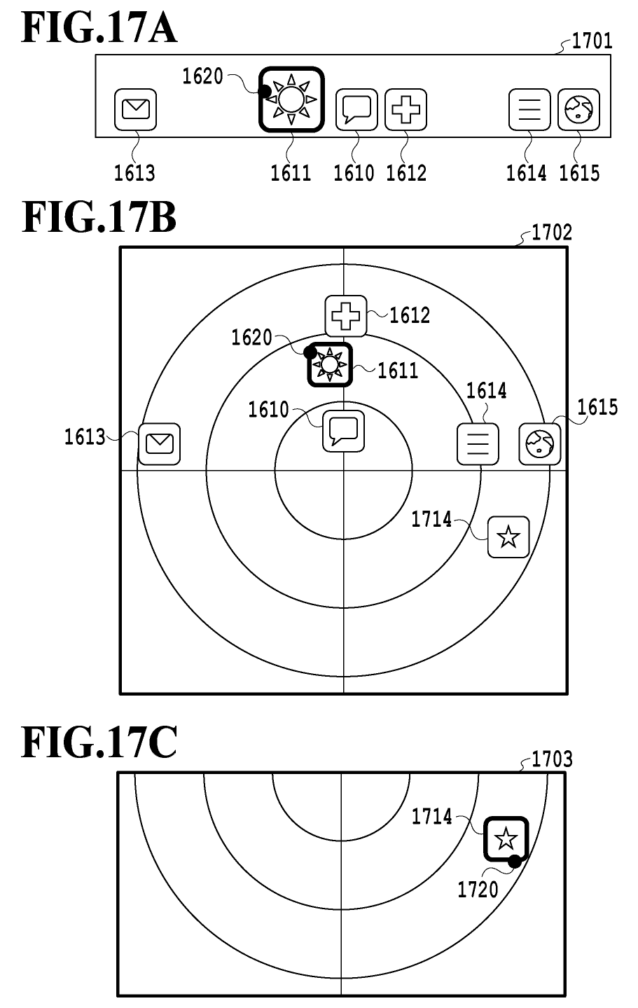

FIG. 17A to FIG. 17C are diagrams illustrating other embodiment examples of the map generated by the map generating unit 1416. The map generating unit 1416 may generate the one-dimensional map 1701 as illustrated in FIG. 17A, instead of the two-dimensional map 1600. In this case, the window control unit 204, for example, makes the center of the one-dimensional map 1701 correspond to the front direction 402 of the user 400 extracted in S1502. Further, the window control unit 204 arranges the icons 1610 to 1615 corresponding to the respective windows 410 to 415 on the one-dimensional map 1701, based on an angular deviation of each window 410 to 415 to the left or right from the front direction 402.

Alternatively, the map generating unit 1416 may generate the circular two-dimensional map 1702 as illustrated in FIG. 17B, instead of the two-dimensional map 1600. In this case, the processing performed by the front-direction window extracting unit 205, i.e., the processing of S1502, may be skipped. Further, the window control unit 204 arranges, on the two-dimensional map 1702, the icons 1610 to 1615 and 1714 corresponding to all the windows 410 to 416 present in the three-dimensional space 420. By displaying the circular two-dimensional map 1702, the user 400 may designate and move the window 416, which is present behind them, without changing their orientation. Further, it is also possible for the map generating unit 1416 to generate and display the semicircular two-dimensional map 1703 representing the area behind the user 400, as illustrated in FIG. 17C. Even in this case, the user 400 may designate and move the window 416, which is present behind them, without changing their orientation.

As described above, according to one or more further embodiments, even in a case where a window is occluded by another window in the initial state P1, the occluded window may be designated.

### Other Embodiments

Note that, in the description of the embodiments above, the HMD 101 also functions as an information processing apparatus, and the HMD 101 functioning as an information processing apparatus controls the display of windows, which are virtual objects; however, this configuration is one example and other configurations may also be used. For example, an external information processing apparatus that may communicate with the HMD 101 may have all or part of the functional units illustrated in FIG. 2, FIG. 8, and FIG. 14, and the external information processing apparatus may perform processing of all or part of the steps in the above-described flowcharts.

Further, in the description of the embodiments above, the processing-target window is a window that is to be moved; however, the processing does not necessarily have to be performed on the processing-target window. For example, in a case where an application that generates a screenshot generates a screenshot of a window, the above-described flowcharts may end once a processing-target window is determined. The application will then generate the screenshot.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-014961, filed January 31, 2025, which is hereby incorporated by reference herein in its entirety.

What is claimed is:

1. An information processing apparatus for performing a process for displaying a predetermined three-dimensional space as viewed from or by a user, the information processing apparatus comprising:
one or more processors that operate to:
extract one or more virtual objects placed in a direction viewed by the user in the predetermined three-dimensional space;
change a display of the extracted one or more virtual objects such that the extracted one or more virtual objects operate to be identified; and
determine, based on an operation by the user, any one of the extracted one or more virtual objects as a processing-target virtual object.

2. The information processing apparatus according to claim 1,
wherein the one or more processors operate to control or change the display such that thumbnails corresponding to the respective extracted one or more virtual objects are displayed in the direction viewed by the user in the predetermined three-dimensional space, and
wherein the one or more processors determine, as the processing-target virtual object, the virtual object corresponding to a thumbnail designated based on an operation by the user from among the thumbnails.

3. The information processing apparatus according to claim 2,
wherein the one or more processors further operate to display the thumbnails in an order based on distances between the extracted one or more virtual objects and the user.

4. The information processing apparatus according to claim 1,
wherein the one or more processors further operate to change an opacity such that the extracted one or more virtual objects become more transparent than one or more other virtual objects.

5. The information processing apparatus according to claim 4, wherein the one or more processors further operate to:
derive a position of a reference point located in a line-of-sight direction of the user in the predetermined three-dimensional space, based on a first operation by the user, and
determine, in response to a second operation by the user, a virtual object located at a position closest to the reference point as the processing-target virtual object.

6. The information processing apparatus according to claim 4, wherein the one or more processors further operate to:
derive a size of a selection reference circle centered on the user in the predetermined three-dimensional space, based on a first operation by the user, and
determine the processing-target virtual object, based on the selection reference circle.

7. The information processing apparatus according to claim 1,
wherein the one or more processors further operate to control or change the display such that icons corresponding to the respective extracted one or more virtual objects are displayed.

8. The information processing apparatus according to claim 7,
wherein the icons are displayed on a map representing the predetermined three-dimensional space, and each of the icons is displayed at a position on the map, the position on the map indicating a position in the predetermined three-dimensional space in which the respective virtual object of the extracted one or more virtual objects is placed.

9. The information processing apparatus according to claim 8,
wherein the map is a bird's-eye view having an upward direction corresponding to a front direction of the user.

10. The information processing apparatus according to claim 1,
wherein the one or more processors further operate to make the processing-target virtual object a virtual object that can be moved in response to an operation by the user.

11. The information processing apparatus according to claim 1,
wherein the one or more processors further operate to move the processing-target virtual object to a position that is not occluded by another virtual object as viewed from the user.

12. The information processing apparatus according to claim 1,
wherein, in a case where any other virtual object is present between the processing-target virtual object and the user in the predetermined three-dimensional space, the one or more processors further operate to change a position of the other virtual object or hide the other virtual object.

13. The information processing apparatus according to claim 1,
wherein the one or more processors further operate to cause content displayed on the processing-target virtual object to be displayed on a virtual object located in front of the user.

14. The information processing apparatus according to claim 1,
wherein the direction viewed by the user is either a front direction or a line-of-sight direction of the user, and
wherein the one or more processors further operate to extract, from among virtual objects present in the predetermined three-dimensional space, each virtual object in which an angle formed by the front direction or the line-of-sight direction and a direction from the user to the virtual object is equal to or less than a predetermined value.

15. The information processing apparatus according to claim 1,
wherein the one or more virtual objects are windows that display content of an application.

16. The information processing apparatus according to claim 1, wherein the one or more processors further operate to:
generate a rendering image representing the predetermined three-dimensional space as viewed from a position of the user, and
display the rendering image on a display device worn by the user.

17. The information processing apparatus according to claim 1, further comprising:
a display or a display device that operates to be wearable by the user and to display the predetermined three-dimensional space as viewed from or by the user.

18. An information processing method for performing a process for displaying a predetermined three-dimensional space as viewed from or by a user, the information processing method comprising:
extracting one or more virtual objects placed in a direction viewed by the user in the predetermined three-dimensional space;
changing a display of the extracted one or more virtual objects such that the extracted one or more virtual objects operate to be identified; and
determining, based on an operation by the user, any one of the extracted one or more virtual objects as a processing target.

19. A non-transitory computer readable storage medium storing a program which causes a computer to perform a control method of an information processing method for performing a process for displaying a predetermined three-dimensional space as viewed from or by a user, the control method comprising:
extracting one or more virtual objects placed in a direction viewed by the user in the predetermined three-dimensional space;
changing a display of the extracted one or more virtual objects such that the extracted one or more virtual objects operate to be identified; and
determining, based on an operation by the user, any one of the extracted one or more virtual objects as a processing target.
